(19) United States
(12) Patent Application Publication
(10) Pub. No.: US 2001/0049645 A1
(43) Pub. Date: Dec. 6, 2001

(54) Internet boutique system

(75) Inventor: Ryohei Tsukamoto, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/872,094

(22) Filed: Jun. 1, 2001

(30) Foreign Application Priority Data
Jun. 2, 2000 (JP) 2000-166599

(51) Int. Cl. G06F 17/60

(52) U.S. Cl. 705/27

(57) ABSTRACT

An Internet boutique system is disclosed for displaying an image of a user in combination with the image of a commodity to allow the user to determine whether the commodity will fit the user or not. The Internet boutique system has a user image manager and a coordination processor. The user image manager acquires the image of the user from an image capture device and registers the acquired image of the user in a user image database. Then, the coordination processor prompts the user to select a commodity type. When a commodity type is selected, the coordination processor acquires the images of commodities of the selected type from a server and displays the acquired images of commodities from which the user chooses the image of a desired commodity. The selected image is displayed in combination with the image of the user at a suitable position thereon. The user registers the commodity determined to be purchased in a purchased commodity database.

### BACKGROUND OF THE INVENTION

1. Field of the Invention

The present invention relates to an Internet boutique system for selling goods including clothes, ornaments, shoes, bags, etc., in total coordination on the Internet.

2. Description of the Related Art

It has been popular in recent years to sell goods to people, who do not have enough time to actually go to shops, by way of mail order sales or catalog shopping for customers to choose desired goods from a selection of goods introduced by paper catalogs or broadcast programs such as TV programs.

However, the conventional process of presenting information with paper catalogs and broadcast programs such as TV programs only gives customers an opportunity to judge commodities from images of them as they are worn by models in the paper catalogs and the broadcast programs. The users often find it difficult to determine whether the displayed articles will actually fit them or not. In addition, most selling practices associated with such mail order sales or catalog shopping are designed to have a customer select a desired commodity or commodities from the information of one type of goods, such as a group of clothing, shoes, accessories, for example, and fail to give users a chance to purchase different types of goods in total coordination.

### SUMMARY OF THE INVENTION

It is therefore an object of the present invention to provide an Internet boutique system which displays the image of a commodity in combination with the image of a customer to allow the customer to determine whether the commodity will fit the customer or not, and which can coordinate a plurality of items of merchandise in total fashion, a server, a user terminal, and a program thereof.

According to the present invention, an Internet boutique system for selling commodities in total coordination comprises a user terminal and a server that are interconnected via the Internet. The Internet boutique system includes a user image database, user image managing means, coordinating means, and purchase processing means.

The user image managing means acquires an image of a user of the Internet boutique system from outside thereof, and records and manages the image of the user in the user image database. The coordinating means displays the image of a commodity selected by the user from the images of commodities for sale in the Internet boutique system, in combination with the image of the user. The purchase processing means performs a process of purchasing a commodity confirmed by the coordinating means and determined to be purchased by the user.

The user of the Internet boutique system can thus select the image of a desired commodity from the images of the commodities available for sale in the Internet boutique system, and the selected image can be displayed in combination with the image of the user.

Since the user can determine whether the selected commodity will fit the user or not, the user may not purchase any commodity which the user has judged as not fitting the user. The user can purchase various different types of commodities including clothing, ornaments, shoes, bags, etc., in total coordination. Therefore, the user is not required to go around to many shops to purchase commodities in total coordination, and is able to purchase commodities which will fit the user in total coordination in a relatively short period of time.

The user terminal may register articles that the user already owns as images.

The images of those articles that the user has purchased in shops other than the Internet boutique system can be handled as images in the Internet boutique system.

Consequently, the user can purchase a commodity or commodities available in the Internet boutique system in total coordination with an article or articles already in user's possession.

The server may classify the images of commodities according to type, design, color, and other attributes, and record and manage them in a commodity image database. The user terminal may run a coordination program for selecting the image of a desired commodity from the images of commodities for sale in the Internet boutique system, and displaying the selected image in combination with the image of the user.

The provider of the Internet boutique system can construct the server on the Internet and manages data of a plurality of items of merchandise in a unified fashion for selling commodities in total fashion. The user may download the coordination program from the server for use on the user terminal. Thus, the user can access the server from anywhere on the Internet to use the Internet boutique system.

The seller can manage the commodities for use with ease, and can expect an increase in sales based on the practice of selling commodities in total fashion. Inasmuch as the user can use the Internet boutique system anywhere on the Internet, the user can enjoy shopping freely without concern over time and place.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of an Internet boutique system according to a first embodiment of the present invention;

FIG. 2 is a flowchart of a commodity image registering process in a server of the Internet boutique system shown in FIG. 1;

FIG. 3 is a flowchart of a commodity purchasing process in a user terminal of the Internet boutique system shown in FIG. 1;

FIG. 4 is a view showing an image displayed on the user terminal shown in FIG. 3;

FIG. 5 is a flowchart of a commodity purchasing process in a user terminal of an Internet boutique system according to a second embodiment of the present invention; and

FIG. 6 is a view showing an image displayed on the user terminal of the Internet boutique system according to the second embodiment of the present invention.

### DESCRIPTION OF THE PREFERRED EMBODIMENTS

1st Embodiment

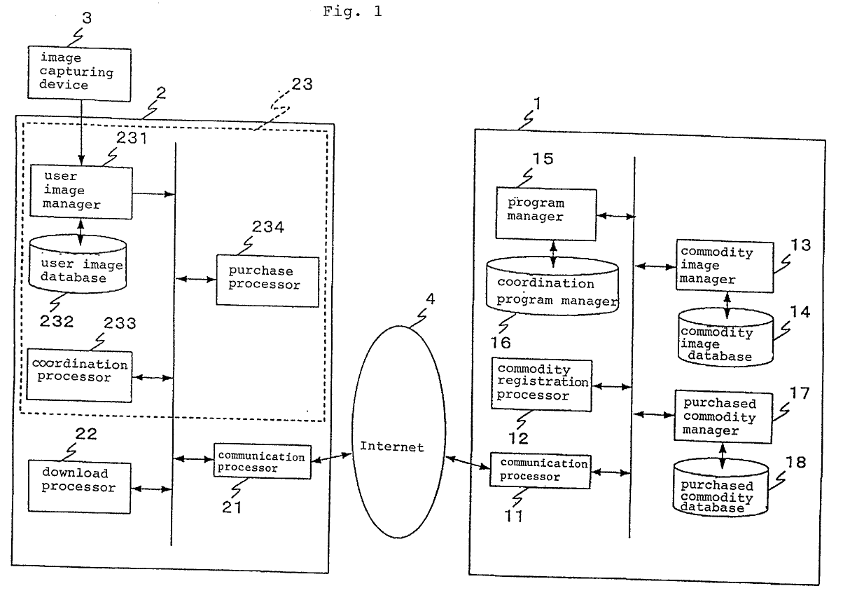

Referring now to FIG. 1, there is shown an Internet boutique system according to a first embodiment of the present invention comprising a server 1, a user terminal 2, an image capturing device 3, and the Internet 4.

The server 1 serves to manage commodity data and a coordination program of the Internet boutique system. The server 1 comprises a communication processor 11, a commodity registration processor 12, a commodity image manager 13, a commodity image database 14, a program manager 15, a coordination program recorder 16, a purchased commodity manager 17, and a purchased commodity database 18.

The communication processor 11 transmits and receives images of commodities for sale, user information, and purchased commodity information, to and from the user terminal 2 via the Internet 4.

The commodity registration processor 12 allows a seller to register images of commodities for sale on the Internet boutique system.

The commodity image manager 13 classifies the registered images supplied from the commodity registration processor 12 according to type, design, color, and other attributes, and records and manages the classified images in the commodity image database 14.

The commodity image database 14 serves to record the registered images supplied from the commodity registration processor 12 which have been classified according to type, design, color, and other attributes.

The program manager 15 manages a coordination program for using the Internet boutique system for use on the user terminal 2, and transmits the coordination program via the communication processor 11 to the user terminal 2.

The coordination program recorder 16 records therein a coordination program to be downloaded via the communication processor 11 to the user terminal 2 for use on the user terminal 2. The coordination program is capable of displaying the images of commodities handled by the Internet boutique system in combination with an image of the user for allowing the user to confirm the commodities.

The purchased commodity manager 17 manages the information of a commodity which the user has confirmed using a coordination program 23 on the user terminal 2 and determined to purchase, in relation to the personal information of the user for settling the payment.

The user terminal 2 is a terminal handled by the user to use the Internet boutique system. The user terminal 2 comprises a communication processor 21, a download processor 22, a user image manager 231, a user image database 232, a coordination processor 233, and a purchase processor 234. The user image manager 231, the user image database 232, the coordination processor 233, and the purchase processor 234 are implemented when the coordination program 23 is executed.

The communication processor 21 transmits and receives images of commodities for sale, user information, and purchased commodity information, to and from the server 1 via the Internet 4.

The download processor 22 downloads the coordination program 23 for using the Internet boutique system from the server 1. The user operates the user terminal 2 to display the image of commodities handled by the Internet boutique system in combination with an image of the user according to the coordination program 23, and determines whether the displayed commodity will fit the user or not.

The user image manager 231 records and manages an image of the user captured by the image capture device 3, which may be a camera, a scanner, or the like that has an imaging unit such as a CCD or the like.

The user image database 23 is a database of images of the user that have been captured by the image capture device 3 and managed by the user image manager 231.

The coordination processor 233 displays the image of commodities handled by the Internet boutique system in combination with an image of the user, and has the user determine whether the displayed commodity will fit the user or not.

The purchase processor 234 transmits data of a commodity which the user has confirmed and wished to purchase in the coordination processor 233, to the server 1 via the Internet 4.

Each of the commodity image database 14, the coordination program recorder 16, and the purchased commodity database 18 of the server 1, and the user image database 232 of the user terminal 2 may comprise a nonvolatile memory such as a hard disk, a magneto-optical disk, a flash memory, or the like, a read-only recording medium such as a CD-ROM or the like, a volatile memory such as a RAM (Random-Access Memory), or a combination of these storage mediums, as they are read by a computer, a recording medium in which data can be written, or information recorded therein.

Each of the communication processor 11, the commodity registration processor 12, the commodity image manager 13, the program manager 15, and the purchased commodity manager 17 of the server 1, and the communication processor 21 and the download processor 22 of the user terminal 2 may comprise a dedicated hardware unit or a combination of a memory and a CPU (Central Processing Unit) which loads a program for performing the functions of those processors and managers into the memory and executes the program to perform the functions.

Peripheral devices including an input device, a display device, etc., (not shown) are connected to the server 1 or the user terminal 2. The input device may comprise a keyboard, a mouse, etc., and the display device may comprise a CRT (Cathode-Ray Tube), a liquid crystal display unit, etc.

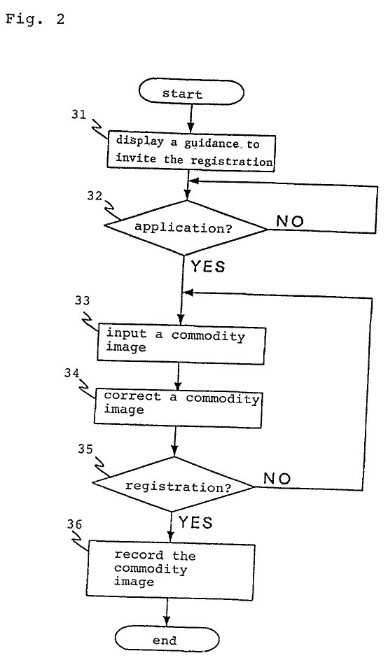

A commodity image registering process in the server 1 will be described below with reference to FIG. 2.

In step 31, the commodity registration processor 12 displays a guidance to invite the registration of a commodity image. If a seller applies for the registration of a commodity image according to the guidance, then the seller operates the server 1 accordingly.

In step 32, the commodity registration processor 12 determines whether there is an application for the registration of a commodity image or not. If there is no application for the registration of a commodity image, then the commodity registration processor 12 waits until the registration of a commodity image is applied for.

If there is an application for the registration of a commodity image, then the commodity registration processor 12 prompts the seller to input a commodity image, and the seller inputs the commodity image in step 33.

In step 34, the commodity registration processor 12 prompts the seller to correct the size, color, etc., of the inputted commodity image, and the seller corrects the size, color, etc., of the inputted commodity image. The size of the commodity image may be corrected by displaying a frame for each commodity type and bringing the profile of the commodity image into conformity with the frame in order to equalize the dimensions of the commodity image to a separately inputted user image or another commodity image. At this time, as many commodity images as the number of commodity sizes available for each commodity design may be inputted, or a differently sized image may be generated from one prepared image based on a scaling ratio according to image processing.

After the commodity image has been corrected, the commodity registration processor 12 prompts the seller to determine whether the commodity image is to be registered or not in step 35. If the seller does not accept the corrected commodity image, then control returns to step 33, and the seller inputs a commodity image again. If the seller accepts the corrected commodity image, then the commodity registration processor 12 controls the commodity image manager 13 to record the commodity image in the commodity image database 14 in step 36.

The commodity image to be recorded in the commodity image database 14 should preferably be a three-dimensional image representing a commodity as worn by a model or window dummy, with unwanted images of face, arms, legs, etc., being removed, so that the commodity image will not look unnatural when subsequently combined with an image of the user.

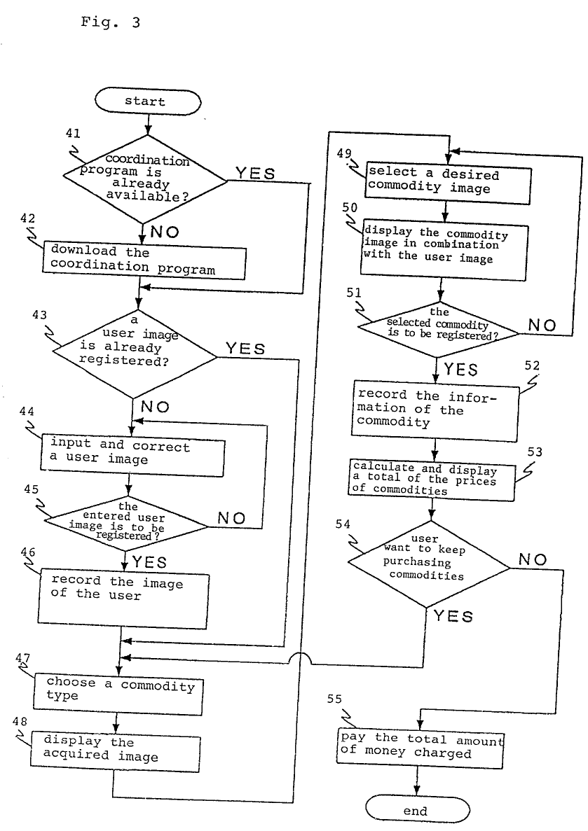

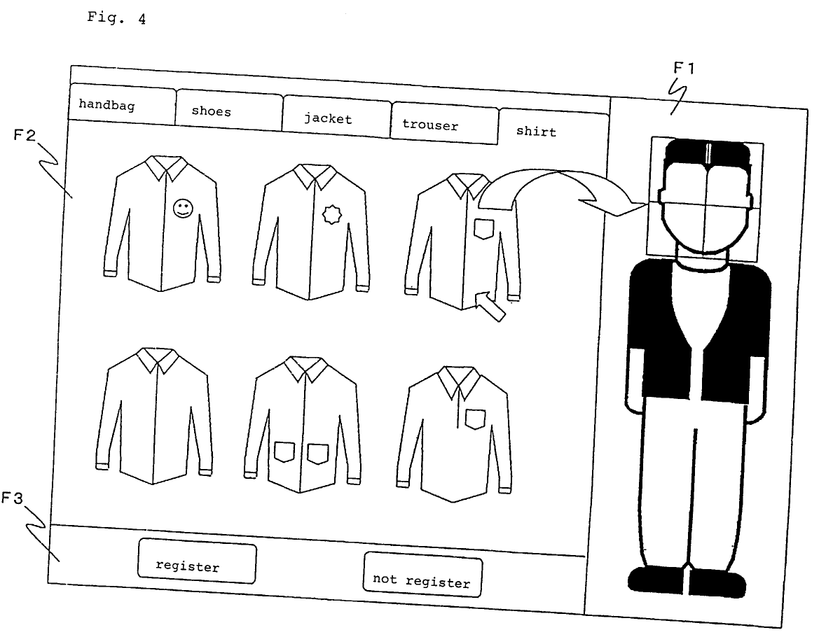

A commodity purchasing process in the user terminal 2 will be described below with reference to FIGS. 3 and 4.

In step 41 shown in FIG. 3, the download processor 22 determines whether the coordination program 23 necessary for the user to use the Internet boutique system is already available on the user terminal 2 or not. If the coordination program 23 is not yet available, the download processor 22 downloads the coordination program 23 from the server 1 via the communication processor 21 and the Internet 4 in step 42. If the coordination program 23 is already available, then the download processor 22 executes the available coordination program 23.

When the coordination program 23 is executed, the user image manager 231 implemented thereby determines whether a user image has already been registered or not in step 43. If a user image has not yet been registered, then the user image manager 231 controls the image capture device 3 to input a user image and corrects the inputted user image in step 44. At this time, the user inputs an image of the entire body of the user as indicated by a view or frame F1 in FIG. 4. The size of the user image is corrected such that the size of the face of the user image is just fitted in an indicated frame in order to equalize the size of a commodity to be subsequently displayed in combination to the size of the user image.

FIG. 4 shows an image displayed on the user terminal 2 according to the coordination program 23. The image includes the image of the entire body of the user as a full-length image at a given ratio of horizontal and vertical dimensions in the frame F1, an array of commodity images in a view or frame F2, and control buttons in a view or frame F3.

In step 45, the user image manager 231 prompts the user to determine whether the entered user image is to be registered or not. If the user does not accept the entered user image, then control goes back to step 44, and the user inputs and corrects a user image again. If the user accepts the entered user image, then the user image manager 231 records the full-length image of the user in the user image database 232 in step 46.

If a user image has already been registered in step 43, then the process of inputting a user image is skipped.

After the user image is prepared, the coordination processor 233 prompts the user to choose a commodity type, and the user chooses a commodity type in step 47. Commodity types to choose from may be different items of merchandise including shirts, trousers, jackets, shoes, bags, etc., as indicated in the frame F2 in FIG. 4.

After a commodity type is chosen, the coordination processor 233 acquires the images of commodities registered in the chosen commodity type from the server 1 and displays the acquired images in step 48. For example, when the user selects a page with a tag marked “SHIRTS” in the frame F2 in FIG. 4, the images of different shirts that are available are displayed in the selected page.

Then, the coordination processor 233 prompts the user to select a desired commodity from the displayed commodity images, and the user selects a desired commodity with the input device in step 49. In the frame F2 in FIG. 4, it is assumed that the user has selected the shirt on the left end in the upper row.

After the user has selected the image of the desired shirt, the coordination processor 233 displays in step 50 the selected image in combination with the user image displayed in the frame F1 at a suitable position, e.g., an upper part of the user's body if a shirt is chosen or a lower part of the user's body if trousers are chosen, on the user image. If a commodity, such as a shirt or trousers, is of such a nature that its displayed position is predetermined in combination with the user image, then its displayed position is inputted as information associated with a tagged page for its commodity type, and commodities in the page-are automatically displayed in the displayed position as the associated information. However, some other commodities, such as scarves, are of such a nature that the user may want them to be displayed at a desired position on the user image, such as a neck, a head, or the like. Therefore, the displayed position as the associated information in tagged pages includes “automatic” and “manual” settings, and if the “automatic” setting is selected for a commodity, then the commodity is displayed in the displayed position indicated in the associated information, and if the “manual” setting is selected for a commodity, then the commodity is displayed in the displayed position that has been indicated by the user with the input device.

As many commodity images as the number of commodity sizes available for each commodity design may be displayed, and when a commodity design is selected, an auxiliary menu with a size selection capability may be displayed. Alternatively, a differently sized image may be generated from one prepared image based on a scaling ratio according to image processing.

When the user image and the commodity image are to be displayed in combination with each other, it is also possible to display the image of a commodity which the user has purchased in the Internet boutique system in the past, simultaneously in combination with the user image. According to this process, the user may first purchase a shirt and trousers, and thereafter additionally purchase a shirt that matches the trousers well.

After the selected commodity image and the user image have been displayed in combination with each other, the coordination processor 233 prompts the user to determine whether the selected commodity is to be registered in the purchased commodity database 18 of the server 1 or not in step 51. If the user does not accept the commodity, then control returns to step 49, and the user selects a commodity again.

If the user accepts the commodity, then the coordination processor 233 transmits a signal to register the commodity in the purchased commodity database 18 from the communication processor 21 to the server 1. In step 52, the purchased commodity processor 17 records the information of the commodity in the purchased commodity database 18.

After the information of the commodity has been registered in the purchased commodity database 18, the purchase processor 234 calculates and displays a total of the prices of commodities that have been registered in the purchased commodity database 18 in the present purchase session in step 53.

In step 54, the purchase processor 234 prompts the user to determine whether the user wants to keep purchasing commodities. If the user wants to keep purchasing commodities, then control goes back to step 47, and the coordination processor 233 prompts the user to choose a commodity again. If the user wants to finish the present purchase session, then the purchase processor 234 performs a process of making a payment in the Internet boutique system to have the user to pay the total amount of money charged for the present purchase session in step 55, after which the commodity purchasing process is put to an end. At this time, before the user pays the charged amount of money, the user may be allowed to reconfirm the intention to purchase each and every commodity registered in the purchased commodity database 18 and then to cancel any individual commodity, if any, which the user has decided to buy but changed its mind.

2nd Embodiment

A commodity purchasing process in a user terminal of an Internet boutique system according to a second embodiment of the present invention will be described below with reference to FIGS. 4, 5, and 6. The Internet boutique system according to the second embodiment of the present invention is structurally identical to the Internet boutique system according to the first embodiment of the present invention as shown in FIG. 1.

In the second embodiment, the coordination program 23 that is executed by the user terminal 2 has an additional function to register the image of an article which the user already owns, e.g., an article which has been purchased before in another shop by the user, in the user image database 232, and coordinate the article with a commodity to be newly purchased in the Internet boutique system.

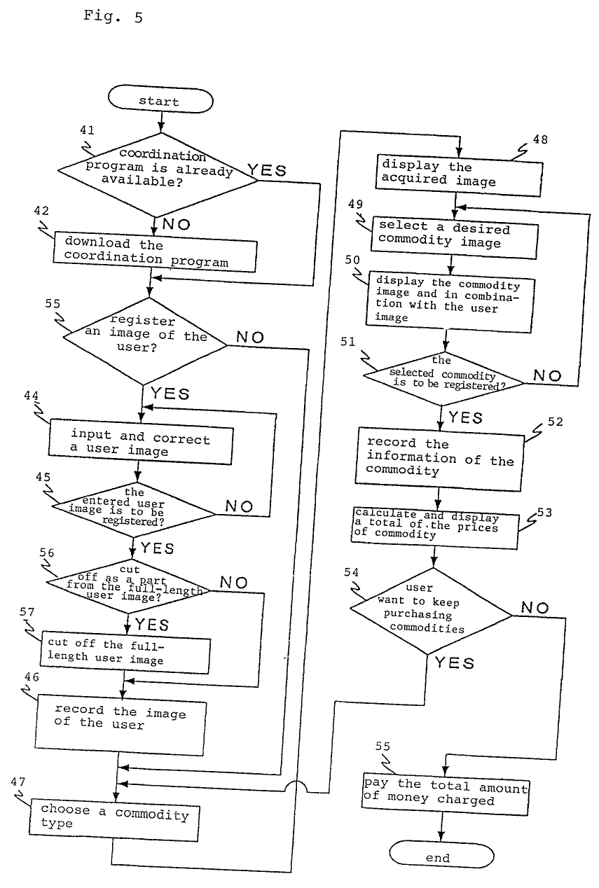

In step 41 shown in FIG. 5, the download processor 22 determines whether the coordination program 23 necessary for the user to use the Internet boutique system is already available on the user terminal 2 or not. If the coordination program 23 is not yet available, the download processor 22 downloads the coordination program 23 from the server 1 via the communication processor 21 and the Internet 4 in step 42. If the coordination program 23 is already available, then the download processor 22 executes the available coordination program 23.

When the coordination program 23 is executed, the user image manager 231 implemented thereby prompts the user to confirm whether to register an image of the user or not in step 55.

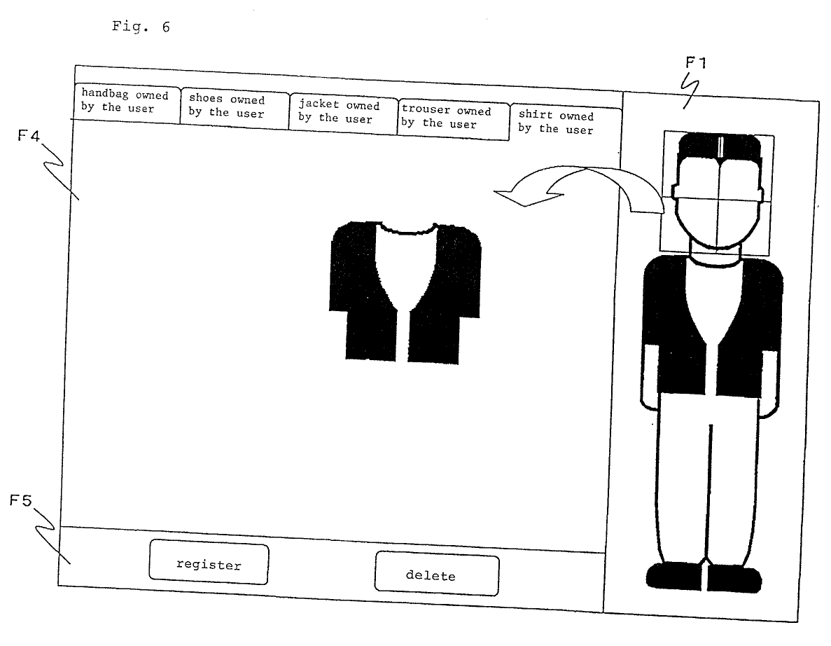

If the user is to register an image of the user, then the user image manager 231 controls the image capture device 3 to input a user image and corrects the inputted user image in step 44. At this time, the user inputs an image of the entire body of the user as indicated by a frame F1 in FIG. 6. The size of the user image is corrected such that the size of the face of the user image is just fitted in an indicated frame in order to equalize the size of a commodity to be subsequently displayed in combination to the size of the user image.

In step 45, the user image manager 231 prompts the user to determine whether the entered user image is to be registered or not. If the user does not accept the entered user image, then control goes back to step 44, and the user inputs and corrects a user image again. If the user accepts the entered user image, then the user image manager 231 prompts the user to determine whether the user image to be registered is the image of an article already owned by the user, which has been cut off as a part from the full-length user image, or not in step 56.

If the user image to be registered is the image of an article already owned by the user, which has been cut off as a part from the full-length user image, then the user image manager 231 cuts off the profile of the image of an article to be registered, from a frame F1 in FIG. 6, and pastes the cut-off image profile to a tagged page for registering a user image, e.g., a page with a tag “USER'S OWN SHIRT” in FIG. 6, in step 57.

FIG. 6 is an image displayed on the user terminal 2 for registering the image of an article already owned by the user according to the coordination program 23. The image includes the image of the entire body of the user as a full-length image at a given ratio of horizontal and vertical dimensions in the frame F1, a registration image in a view or frame F4, and control buttons in a view or frame F5.

After the image profile has been cut off, the user image manager 231 records the image profile in the user image database 232 in step 46.

If the user image to be registered is not the image of an article already owned by the user, which has been cut off as a part from the full-length user image, then the user image manager 231 records the full-length image of the user in the user image database 232 in step 46.

If the user is not required to register an image of the user in step 55, then the process of inputting a user image is skipped.

When the user image or the image of the article already owned by the user is prepared, the coordination processor 233 prompts the user to choose a commodity type, and the user chooses a commodity type in step 47. Commodity types to choose from may be different items of merchandise including shirts, trousers, jackets, shoes, bags, etc., as indicated in the frame F2 in FIG. 4, and also an item representing the image of the article already owned by the user which has been registered as shown in FIG. 6.

Thereafter, the commodity purchasing process according to the second embodiment of the present invention is identical to the commodity purchasing process according to the first embodiment of the present invention. The user selects the image of a desired commodity from the displayed images of commodities with the input device such as a mouse or the like. The selected image is displayed in combination with the user image displayed in the frame F1 at a suitable position, e.g., an upper part of the user's body if a shirt is chosen or a lower part of the user's body if trousers are chosen, on the user image. Then, the user purchases the commodity if the user likes it.

Therefore, the user can coordinate the commodity with the article already owned by the user.

In the first and second embodiments, the user terminal 2 is assumed to be a wired terminal. However, the user terminal 2 may be a wireless terminal such as a portable terminal or a mobile communication terminal insofar as it can be connected to the Internet 4 and can communicate with the server 1.

If the user terminal 2 is a wireless terminal such as a portable terminal or a mobile communication terminal, then the user image manager 231 and the user image database 232 should preferably be incorporated in the server 1 due to limitations on the processing capability and memory capacity of such a wireless terminal. If user image manager 231 and the user image database 232 are incorporated in the server 1, then the user needs to upload an image entered from the image capture device 3 via the user terminal 2 to the server 1, or record an image entered from an image capture device connected to the server 1 directly in the server 1. If the user is to use the user image database 232 via the user image manager 231 from outside of the server 1, then it is desirable to provide an authenticating means for authenticating whether the user is a legitimate user itself or not using a registration ID or password for protection against unauthorized use of the user image database 232.

In the first and second embodiments, the seller registers the image of a commodity in the server 1 by directly operating the server 1 to register the image of the commodity. However, the seller may register the image of a commodity from a seller's terminal that is connected to the Internet 4. In such a modification, rather than entering the image of a commodity from the seller in step 33 shown in FIG. 2, image data may be transmitted from the seller's terminal, and other processing may be carried out remotely from the seller's terminal.

The functions of the above various components of the server 1 and the user terminal 2 may be realized by recording a program performing those functions in a computer-readable recording medium, reading the program from the recording medium into a computer system, and executing the program.

The term “computer system” referred to above encompasses an OS and hardware units such as peripheral devices, and also includes a home page providing environment or a home page displaying environment if a WWW (World Wide Web) system is used. The term “computer-readable recording medium” encompasses a portable medium such as a floppy disk, a magneto-optical disk, ROM, a CD-ROM, or the like, and a storage device such as a hard disk that is incorporated in a computer system. The term “computer-readable recording medium” also encompasses a medium for holding a program over a certain period of time, e.g., a transmission medium or a transmission wave for dynamically holding a program over a short period of time for transmitting the program via a computer network such as the Internet or the like or a communication circuit such as a telephone circuit or the like, or a volatile memory in a computer system which serves as a server or a client in such a program transmitting session.

The above program may be a program for realizing part of the above functions, or a differential file (differential program) for realizing the above functions in combination with a program already stored in a computer system.

While preferred embodiments of the present invention have been described using specific terms, such description is for illustrative purposes only, and it is to be understood that changes and variations may be made without departing from the spirit or scope of the following claims.

What is claimed is

1. An Internet boutique system for selling commodities in total coordination, the system comprising:
a user image database;
user image managing means for acquiring an image of a user of the Internet boutique system from outside thereof, and recording and managing the image of the user in said user image database;
coordinating means for displaying the image of a commodity selected by the user from the images of commodities for sale in the Internet boutique system, in combination with said image of the user;
purchase processing means for performing a process of purchasing a commodity confirmed by said coordinating means and determined to be purchased by said user;
a purchased commodity database; and
purchased commodity managing means for recording and managing data of the commodity determined to be purchased by said user, in said purchased commodity database.

2. An Internet boutique system according to claim 1, further comprising:
commodity registering means for allowing a seller to register the image of a commodity for sale in the Internet boutique system;
a commodity image database; and
commodity image managing means for classifying the images of commodities for sale which are registered by said commodity registering means according to at least type, design, and color, and recording and managing the classified images of commodities in said commodity image database.

3. An Internet boutique system according to claim 1, wherein said coordinating means comprises means for simultaneously displaying a first view of a plurality of images of commodities for sale in the Internet boutique system, and a second view of a combination of the image of the selected commodity and the image of the user, separately from each other.

4. An Internet boutique system according to claim 3, wherein said second view includes a portion at a given ratio of horizontal and vertical dimensions, and said first view is disposed in an area other than said second view.

5. An Internet boutique system according to claim 4, wherein said first view includes a pair of portions displayed on opposite sides of said second view, and said coordinating means comprises means for displaying a plurality of images of commodities of different types respectively in said portions of the first view.

6. An Internet boutique system according to claim 4, wherein said given ratio of horizontal and vertical dimensions is substantially equal to a ratio horizontal and vertical dimensions of a human body.

7. An Internet boutique system according to claim 1, wherein said user image managing means comprises means for extracting an image in a prespecified range from the acquired image of the user, and recording and managing the extracted image in said user image database.

8. A server comprising:
a communicating means for transmitting and receiving the image of a commodity for sale in an Internet boutique system and data of a user, via the Internet to and from a user terminal connected to the Internet;
a purchased commodity database; and
purchased commodity managing means for recording and managing data, which is included in the data received by said communicating means, of a commodity determined to be purchased by a user of the Internet boutique system, in said purchased commodity database.

9. A server according to claim 8, further comprising:
commodity registering means for allowing a seller to register the image of a commodity for sale in the Internet boutique system;
a commodity image database; and
commodity image managing means for classifying the images of commodities for sale which are registered by said commodity registering means according to at least type, design, and color, and recording and managing the classified images of commodities in said commodity image database.

10. A server according to claim 8, further comprising:
program managing means for transmitting, from said communicating means, a coordination program for combining the image of the commodity for sale in the Internet boutique system with an image of the user to confirm how the combined images are coordinated with each other.

11. A server according to claim 8, further comprising:
a user image database; and
user image managing means for acquiring an image of the user from outside of the Internet boutique system, and recording and managing the image of the user in said user image database.

12. A server according to claim 11, wherein said user image managing means comprises means for extracting an image in a prespecified range from the acquired image of the user, and recording and managing the extracted image in said user image database.

13. A server according to claim 11, further comprising:
authenticating means for authenticating the user when the user uses said user image database via said user image managing means from outside of said server.

14. A user terminal comprising:
a user image database;
user image managing means for acquiring an image of a user of an Internet boutique system from outside thereof, and recording and managing the image of the user in said user image database;
coordinating means for displaying the image of a commodity selected by the user from the images of commodities for sale in the Internet boutique system, in combination with said image of the user;
purchase processing means for performing a process of purchasing a commodity confirmed by said coordinating means and determined to be purchased by said user; and
communicating means for transmitting and receiving the images of commodities for use in the Internet boutique system, information of the user, and information of the commodity determined to be purchased, via the Internet to and from a server.

15. A user terminal according to claim 14, wherein said user image managing means comprises means for extracting an image in a prespecified range from the acquired image of the user, and recording and managing the extracted image in said user image database.

16. A user terminal according to claim 14, further comprising:
authenticating means for authenticating the user when the user uses said user image database via said user image managing means from outside of said server.

17. A user terminal according to claim 14, further comprising:
downloading means for downloading, from said communicating means, a coordination program to realize said user image managing means, said user image database, and said coordinating means.

18. A computer program for use in a user terminal in the Internet boutique system, said program comprising:
a first set of instructions for acquiring an image of a user of an Internet boutique system from outside of said user terminal, and recording and managing the image of the user in a user image database;
a second set of instructions for displaying the image of a commodity selected by the user from the images of commodities for sale in the Internet boutique system, in combination with said image of the user; and
a third set of instructions for performing a process of purchasing a commodity determined to be purchased by said user.
